(19) United States
(12) Patent Application Publication
(10) Pub. No.: US 2009/0077877 A1
(43) Pub. Date: Mar. 26, 2009

(54) METHOD AND APPARATUS FOR PRECLUDING PLANT TRUNKS FROM FREEZING

(76) Inventors: Richard Kerber, Niagara-on-the-Lake (CA); Thomas Kerber, Stoney Creek (CA)

Correspondence Address: Richard Kerber, Unit 104, 944 South Service Road, Stoney Creek, ON, L8E 6A2, CA

(21) Appl. No.: 11/463,308

(22) Filed: Aug. 8, 2006

(51) Int. Cl. A01G 13/02

(52) U.S. Cl. 47/29.5; 47/20.1

(57) ABSTRACT

An apparatus for precluding plant trunks from freezing comprises an electrically powered heating means, for placement adjacent a plant trunk, to thereby warm the plant trunk. An insulating means is provided for surrounding the electrically powered heating means and the plant trunk, to thereby retain heat generated by the electrically powered heating means around the plant trunk.

### FIELD OF THE INVENTION

The present invention relates to a method and apparatus for precluding plant trunks from freezing, and more particularly to a method and apparatus for precluding the trunks of grape vines from freezing.

### BACKGROUND OF THE INVENTION

In many areas of the world, grapes are grown in climates that are temperate most of the year around, or at least that do not experience harsh winters. Accordingly, the grapes that have been grown in such areas are especially suited for the particular local climate and soil. In some countries, such as France and Italy, some types of grape vines, such as Vinifera™ grape vines, have been developed over a period of few centuries to provide a superior taste, or other desired qualities, and to flourish in their native climate and soil.

Over the past several decades, it has become common to grow grapes, for the purpose of making wine, in less temperate climates, where winters can be quite harsh. In order to help less hearty types of grape vines, such as Vinifera™ grape vines, flourish as best possible in cooler climates, they are grafted to strong well-established generic roots that are typically of a type that is hearty and conducive to survival in local soil and growing conditions. While this technique does allow less hearty types of grape vines to flourish on an overall basis, they generally cannot survive the cold winter months experienced in colder climates. This is especially true of Vinifera™ grape vines. Accordingly, two specific methods are used to allow less hearty types of grape vines to survive cold winter months, especially Vinifera™ grape vines.

The first method is to use a very large specially designed fan to circulate and blend air over a field of grape vines, typically during cold winter nights when the temperature is below a threshold value. These very large fans can circulate air effectively in an area of up to about ten acres, and tend to circulate the warmer air from about thirty feet down to the level of the grape vines. In this manner, the grape vines are usually kept above a temperature of about minus twenty degrees Celcius (−20° C.), and according are not damaged by freezing; however, there are numerous problems associated with the use of such circulating fans. These circulating fans typically cost about $30,000 each. If a vineyard is, for instance, one hundred acres in size, ten circulating fans would be required, at a total capital cost of about $300,000, which is quite prohibitive. Further, these circulating fans cost about $35/hour to run, are expensive to maintain, especially since they are used only during very cold winter nights, and are quite noisy, which is an important consideration near homes.

Also since these circulating fans are located in the interiorly within a vineyard, they tend to block equipment such as spraying equipment and other devices, and repair trucks cannot readily gain access to them.

The second method is to physically protect a lower portion of the grape vine plants. Grape vine plants are typically planted in rows about five hundred to one thousand feet long, with the rows spaced apart one from the next by about nine feet. The trunks of the grape vine plants extend upwardly from a grafted root at regular intervals of about every three feet. Due to the overall physical positioning and arrangement of the vines, air from the large circulating fans does not circulate close enough to the ground to have a substantial effect on the trunks of the grape vines. Accordingly, it is common to physically protect the grafts of the trunks to the roots, and also the lower section of the trunks, by piling soil around the area of each graft to a height of perhaps a foot or so (known as “hilling”). Such “hilling” precludes the grafts and the lower section of the trunks from freezing, thus helping to keep the plant alive. While “hilling” does work effectively, there remains a very significant problem. The hills of soil can be constructed to a height of only about twelve inches or so, unless additional soil is used, which generally is not a cost effective option; however, the trunks of the vines are typically well over forty-eight inches in height, and are often unprotected up to about twenty inches in height (up to the first horizontal tie-up wire). Unfortunately, “hilling” the entire twenty inches of trunk is usually not practical since more soil is required than is readily available. Accordingly, the upper portions of the grape vine trunks directly open to the environment during the winter. When the ambient temperature reaches below about minus twenty degrees Celcius (−20° C.), the upper portion of the grape vine trunks and also the buds may freeze to a point of where they are damaged, depending on the particular variety of vine.

It has been found that air from the large circulating fans does not circulate close enough to the ground to have a substantial effect on the exposed portions of the trunks of the grape vines between the first horizontal tie-up wire and the hills of soil.

Once the exposed portions of the grape vine trunks have frozen too severely, the trunk has become damaged and cannot conduct liquid in the springtime. Even if the roots and the grape vines are healthy, the vines will soon die.

It is therefore necessary to maintain the exposed portions of the grape vine trunks just above −minus twenty degrees Celcius (−20° C.) so that they do not freeze too severely.

There are also other problems with “hilling”. Generally, “hilling” is labour intensive and therefore undesirable. Also, the hills have to be removed in the springtime, which is also labour intensive. Further, the hills of soil are often large enough to make it difficult for the maintenance personnel who prune the grape vines during the winter from readily reaching the vines. Also, the hills might have to be formed quite quickly just prior to a sudden severe pending drop in temperature, and there might not be enough time available.

It is an object of the present invention to provide an apparatus for precluding plant trunks from freezing.

It is another object of the present invention to provide an apparatus for precluding plant trunks from freezing, specifically grape vine plants.

It is a further object of the present invention to provide an apparatus for precluding plant trunks from freezing, specifically grape vine plants, which apparatus protects types of grape vine plants that are not overly hardy.

It is a further object of the present invention to provide an apparatus for precluding plant trunks from freezing, specifically grape vine plants, which apparatus is low cost.

It is a further object of the present invention to provide an apparatus for precluding plant trunks from freezing, specifically grape vine plants, which apparatus can be used in any size and shape of vineyard.

It is a further object of the present invention to provide an apparatus for precluding plant trunks from freezing, specifically grape vine plants, which apparatus is inexpensive to operate.

It is a further object of the present invention to provide an apparatus for precluding plant trunks from freezing, specifically grape vine plants, which apparatus is inexpensive to maintain.

It is a further object of the present invention to provide an apparatus for precluding plant trunks from freezing, specifically grape vine plants, which apparatus is reliable.

It is a further object of the present invention to provide an apparatus for precluding plant trunks from freezing, specifically grape vine plants, which apparatus is quiet during operation.

It is a further object of the present invention to provide an apparatus for precluding plant trunks from freezing, specifically grape vine plants, which apparatus does not block equipment such as spraying equipment and other devices.

It is a further object of the present invention to provide an apparatus for precluding plant trunks from freezing, specifically grape vine plants, which apparatus minimizes or eliminates the need for “hilling”.

It is a further object of the present invention to provide an apparatus for precluding plant trunks from freezing, specifically grape vine plants, which apparatus does not need to be applied or mounted suddenly in the event of a pending severe temperature drop.

### SUMMARY OF THE INVENTION

In accordance with one aspect of the present invention there is disclosed a novel apparatus for precluding plant trunks from freezing. The apparatus comprises an electrically powered heating means, for placement adjacent a plant trunk, to thereby warm the plant trunk. An insulating means is provided for surrounding the electrically powered heating means and the plant trunk, to thereby retain heat generated by the electrically powered heating means around the plant trunk.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the apparatus for precluding plant trunks from freezing according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a side elevational view of a row of vines in a conventional vineyard, with the preferred embodiment of the apparatus for precluding plant trunks from freezing according to the present invention installed thereon.

### DETAILED DESCRIPTION OF A PREFERRED EMBODIMENT

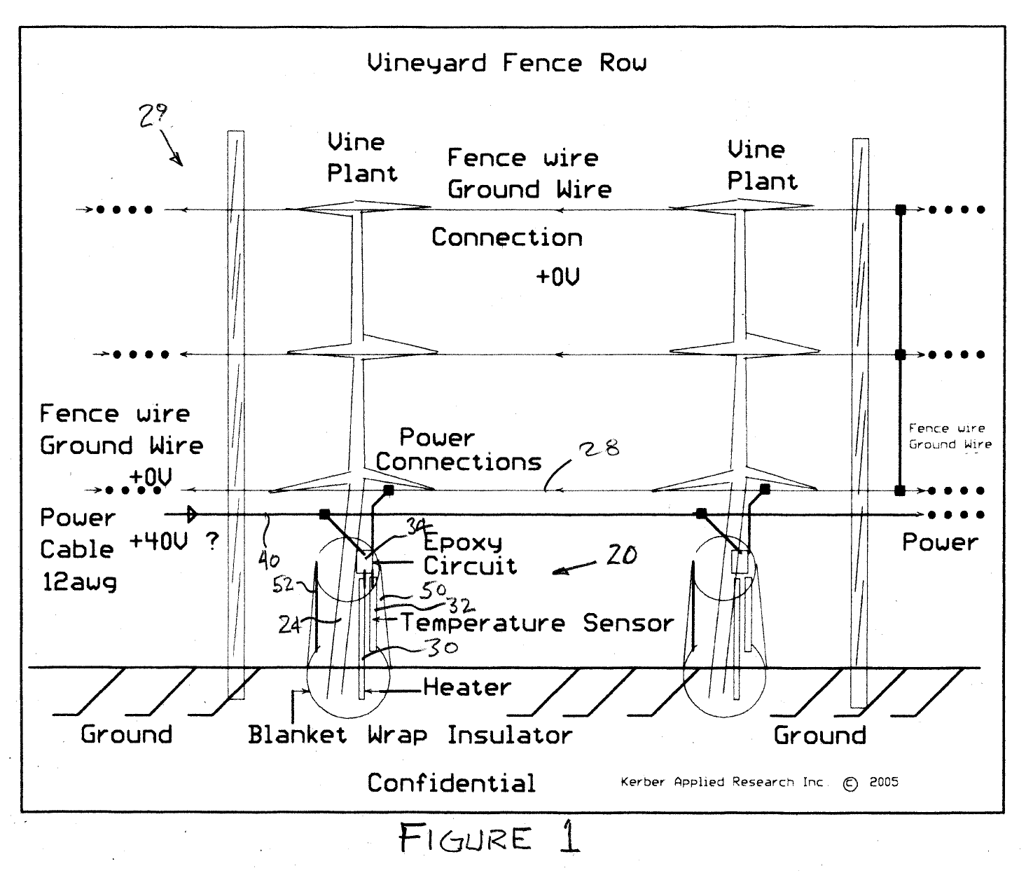

Reference will now be made to FIG. 1, which shows a first preferred embodiment of the apparatus for precluding plant trunks from freezing of the present invention, as indicated by general reference numeral 20. The apparatus 20 comprises an electrically powered heating means 30, for placement adjacent a plant trunk, to thereby warm the plant trunk. Preferably, the electrically powered heating means 30 comprises an electrically powered heating element 30 that is configured to operate at about forty volts and below, for the sake of safety. The electrically powered heating element 30 is electrically connectable to the tie-up wires 28 of the grape vine fence 29, which acts as the ground portion of the electrical circuit. An electrical power cable 40 is connected the opposite side of the electrically powered heating element 30 for supplying electrical power thereto.

The apparatus 20 also comprises an insulating means 50 for surrounding the electrically powered heating element 30 and the plant trunk 24, to thereby retain heat generated by the electrically powered heating element 30 around the plant trunk 24. The insulating means 50 preferably comprises a blanket means 50 that wraps around the electrically powered heating element 30 and the plant trunk 24, and secures to itself by means of Velcro™ 52 or any other suitable fastening means. In this manner, a range of sizes of plant trunks 24 can be accommodated. The bottom portion of a typical grape vine trunk is about ¾ inches in diameter for a three year old plant and about two to four inches in diameter for ten year old plant.

Alternatively, it is possible to use stretchy black ties that are commonly used to tie the grape vine trunks 24 to the wire fence 28. Also alternatively, a cylinder or cone, or any other suitable made from a more rigid insulating material, such as foam (e.g. Styrofoam™), could be used.

The apparatus 20 further comprises a temperature sensor 32 electrically connected to the electrically powered heating element 30 for placement adjacent to the plant trunk 24 so as to be surrounded by the insulating blanket means 50. There is also an electronic control circuit 34 electrically connected to the temperature sensor 32 and the electrically powered heating element 30, for controlling electrical power applied to the electrically powered heating element 30. The temperature sensor 32 and electronic control circuit 34 keep the temperature within the insulating blanket means 50 to a selected temperature (preferably about minus twenty degrees Celcius (−20° C.)) in order to preclude the plant trunk 24 from severely freezing, and also to preclude the plant trunk 24 from becoming too warm.

In the preferred embodiment of the apparatus 20 of the present invention, the electrically powered heating element 30, the electronic control circuit 34 and the temperature sensor 32 are preferably separate from the insulating blanket means 50. In this manner, the electrically powered heating element 30, the electronic control circuit 34 and the temperature sensor 32 can be kept in place throughout the year, and the insulating blanket means 50 can be very quickly put in place around each plant trunk 24 at the first sign of cold temperatures.

Alternatively, the electrically powered heating element 30, the electronic control circuit 34 and the temperature sensor 32 are either permanently or removably mounted within the insulating blanket means 50. In this manner, when the insulating blanket means 50 is put in place around a plant trunk 24, the electrically powered heating element 30, the electronic control circuit 34 and the temperature sensor 32 must be electrically connected to the power cable and ground (the tie-up wires 28 of the grape vine fence 29), which is more time consuming.

With the apparatus of the present invention, the insulating blanket means 50 can be hilled up slightly with dirt to seal the lower part of jacket to the earth for increased insulation purposes. It can also readily be seen that the apparatus of the present invention reduces the size of hill of soil or even eliminate the need for a hill of soil.

The apparatus for precluding plant trunks from freezing, according to the present invention, may be configured that each circuit heats an entire row of vines, or a partial row of vines, or just one vine. Further, the present invention can be used with many different types of plants, including, but not limited to, vines, fruit trees, ornamental roses, and so on.

As can be understood from the above description and from the accompanying drawings, the present invention provides an apparatus for precluding plant trunks from freezing, which apparatus is specifically grape vine plants, protects types of grape vine plants that are not overly hardy, is low cost, can be used in any size and shape of vineyard, is inexpensive to operate, is inexpensive to maintain, is reliable, is quiet during operation, does not block equipment such as spraying equipment and other devices, minimizes or eliminates the need for “hilling”, and does not need to be applied or mounted suddenly in the event of a pending severe temperature drop, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the Apparatus for precluding plant trunks from freezing of the present invention, without departing from the spirit and scope of the accompanying claims.

I claim:

1. Apparatus for precluding plant trunks from freezing, said apparatus comprising:
an electrically powered heating means, for placement adjacent a plant trunk, to thereby warm said plant trunk;
an insulating means for surrounding said electrically powered heating means and said plant trunk, to thereby retain heat generated by said electrically powered heating means around said plant trunk.

2. The apparatus of claim 1, wherein said electrically powered heating means comprises an electrically powered heating element.

3. The apparatus of claim 1, wherein said electrically powered heating means is electrically connectable to the tie-up wires of the grape vine fence.

4. The apparatus of claim 1, wherein said insulating means comprises a blanket means.

5. The apparatus of claim 1, further comprising a temperature sensor electrically connected to said electrically powered heating means for placement adjacent to said plant trunk so as to be surrounded by said insulating means, and an electronic control circuit electrically connected to said temperature sensor and said electrically powered heating means, for controlling electrical power applied to said electrically powered heating means.

6. The apparatus of claim 2, wherein said electrically powered heating element is configured to operate at about forty volts and below.
